(19) United States
(12) Patent Application Publication
(10) Pub. No.: US 2025/0308252 A1
(43) Pub. Date: Oct. 2, 2025

(54) TOWED VEHICLE MARK AND MARK DETECTION DEVICE

(71) Applicant: AISIN CORPORATION, Kariya (JP)

(72) Inventor: Kota ITO, Kariya-shi (JP)

(73) Assignee: AISIN CORPORATION, Kariya (JP)

(21) Appl. No.: 19/081,015

(22) Filed: Mar. 17, 2025

(30) Foreign Application Priority Data
Mar. 29, 2024 (JP) 2024-057767

(51) Int. Cl. G06V 20/58; B60D 1/36; G06V 10/25; G06V 10/44

(52) U.S. Cl. CPC G06V 20/58; B60D 1/36; G06V 10/25; G06V 10/44

(57) ABSTRACT

A towed vehicle mark is to be provided on a towed vehicle that is couplable to a towing vehicle so as to be imaged by an imaging unit in the towing vehicle. The towed vehicle mark includes a first region, and a second region arranged adjacent to the first region and has a color different from a color of the first region. A boundary line between the first region and the second region is a straight line longer than a sum of a width of the first region in an arrangement direction of the first region and the second region and a width of the second region in the arrangement direction.

### CROSS REFERENCE TO RELATED APPLICATIONS

This application is based on and claims priority under 35 U.S.C. § 119 to Japanese Patent Application 2024-057767, filed on Mar. 29, 2024, the entire content of which is incorporated herein by reference.

### TECHNICAL FIELD

This disclosure relates to a towed vehicle mark and a mark detection device.

### BACKGROUND DISCUSSION

In the related art, a towing vehicle (tractor) that tows a towed vehicle (trailer) is known. A towing device including a towing bracket and a coupling ball (hitch ball) is provided at a rear portion of the towing vehicle, and a towed device (coupler) is provided at a tip end of the towed vehicle. By connecting the hitch ball to the coupler, the towing vehicle tows the towed vehicle in a pivotable manner. In this type of technique, for example, a mark attached to a front portion of the towed vehicle is imaged by a camera provided at the rear portion of the towing vehicle, a straight line is detected from the mark by image processing, and a bending angle (hitch angle) of the towed vehicle changing with respect to the towing vehicle is detected. As the mark, a checkered pattern in which black and white squares are combined is known (for example, JP 2019-199150A (Reference 1)).

However, in the related art, a bending angle of a non-towing vehicle is calculated by detecting a central position of a mark and a central position of a coupling shaft. Therefore, there are a detection error for the central position of the mark and a detection error for the central position of the coupling shaft, and these errors may be larger in calculating the bending angle of the towed vehicle. Therefore, it is desired to develop a towed vehicle mark that improves accuracy of detecting the bending angle of the towed vehicle.

A need thus exists for a towed vehicle mark and a mark detection device which are not susceptible to the drawback mentioned above.

### SUMMARY

According to an aspect of this disclosure, a towed vehicle mark is to be provided on a towed vehicle that is couplable to a towing vehicle so as to be imaged by an imaging unit in the towing vehicle. The towed vehicle mark includes a first region and a second region arranged adjacent to the first region and has a color different from a color of the first region. A boundary line between the first region and the second region is a straight line longer than a sum of a width of the first region in an arrangement direction of the first region and the second region and a width of the second region in the arrangement direction.

According to another aspect of this disclosure, a mark detection device includes an acquisition unit configured to acquire captured image data obtained by imaging the above-described towed vehicle mark from the imaging unit, and a detection unit configured to detect the towed vehicle mark from the captured image data and detect a straight line corresponding to the boundary line from the detected towed vehicle mark.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating an example of a coupling state between a towing vehicle and a towed vehicle according to an embodiment;

FIG. 2 is a plan view schematically illustrating an example of the coupling state between the towing vehicle and the towed vehicle according to the embodiment;

FIG. 3 is a plan view schematically illustrating an example of a coupling member of the towed vehicle provided with a towed vehicle mark according to the embodiment;

FIG. 4 is a block diagram illustrating a configuration of a periphery monitoring system including an ECU as a mark detection device according to the embodiment;

FIG. 5 is a block diagram illustrating a configuration of a CPU in the ECU according to the embodiment;

FIG. 6 is a diagram illustrating an example of image processing and is a diagram illustrating processing of specifying a position of a mark in captured image data according to the embodiment;

FIG. 7 is a diagram illustrating an example of image processing and is a diagram illustrating template matching processing according to the embodiment;

FIG. 8 is a diagram illustrating an example of image processing and is a diagram illustrating straight line detection processing according to the embodiment; and

FIG. 9 is a flowchart illustrating an example of processing executed by the CPU according to the embodiment.

### DETAILED DESCRIPTION

Hereinafter, exemplary embodiments disclosed here will be described. Configurations of the embodiments to be described below, and operations, results, and effects of the configurations are examples. The embodiments disclosed here can be implemented by configurations other than the configurations disclosed in the embodiments to be described below, and at least one of various effects based on a basic configuration and a derivative effect can be obtained.

### Towing Vehicle 10 and Towed Vehicle 12

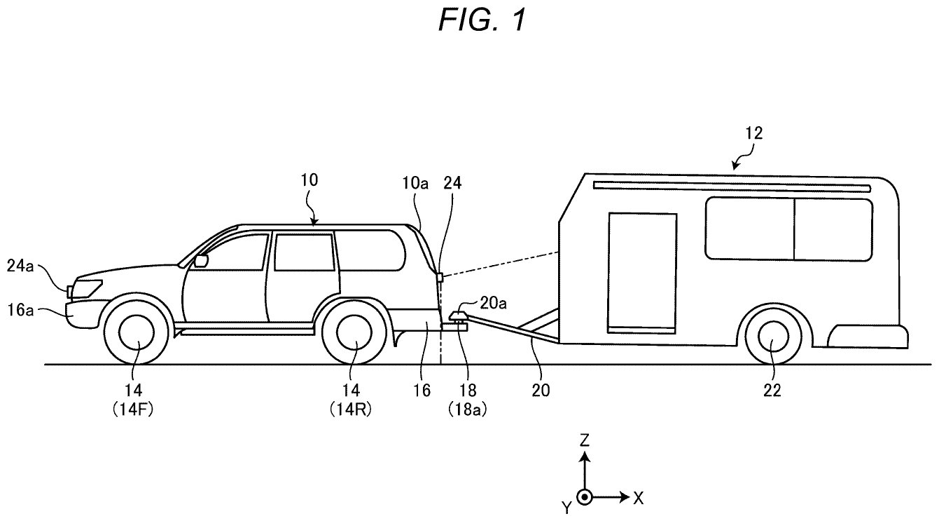

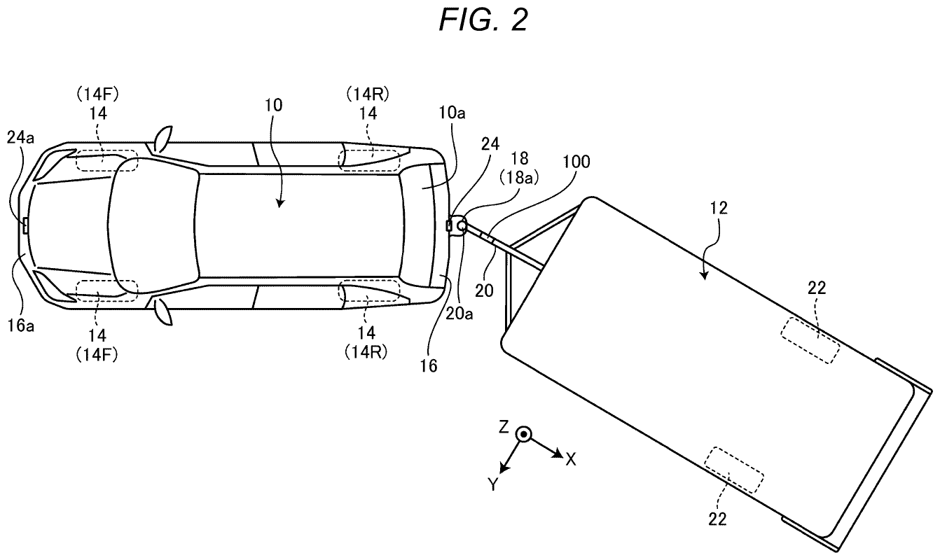

FIG. 1 is a side view illustrating a towing vehicle 10 and a towed vehicle 12 towed by the towing vehicle 10 according to an embodiment. FIG. 2 is a plan view of the towing vehicle 10 and the towed vehicle 12 illustrated in FIG. 1.

The towing vehicle 10 may be, for example, an automobile (an internal combustion engine automobile) using an internal combustion engine (an engine, not illustrated) as a drive source, an automobile (an electric automobile, a fuel cell automobile, or the like) using an electric motor (a motor, not illustrated) as a drive source, or an automobile (a hybrid automobile) using both of the internal combustion engine and the electric motor as a drive source. The towing vehicle 10 may be a sport utility vehicle (SUV) as illustrated in FIG. 1, or may be a so-called “pickup truck” with a cargo bed provided on a rear side of the vehicle. The towing vehicle 10 may be a general passenger car. The towing vehicle 10 can be equipped with various transmission devices, and can be equipped with various devices (systems, components, and the like) necessary for driving the internal combustion engine or the electric motor. A method, a number, a layout, and the like of devices related to driving of wheels 14 (front wheels 14F and rear wheels 14R) in the towing vehicle 10 can be set in various manners.

The towed vehicle 12 may be, for example, as illustrated in FIG. 1, a box-type towed vehicle including at least one of a passenger space, a living section, and a storage space, or may be a cargo-bed-type towed vehicle on which a cargo (for example, a container or a boat) is placed. The towed vehicle 12 illustrated in FIG. 1 includes a pair of trailer wheels 22 as an example. The towed vehicle 12 in FIG. 1 is a driven vehicle equipped with driven wheels that neither include driving wheels nor steering wheels.

As illustrated in FIG. 1 and the like, in this specification, an XYZ coordinate system including an X axis, a Y axis, and a Z axis is defined for convenience. The XYZ coordinate system is provided for the towed vehicle 12. The X axis, the Y axis, and the Z axis are orthogonal to one another. The X axis is provided along a front-rear direction of the towed vehicle 12. The Y axis is provided along a left-right direction (width direction) of the towed vehicle 12. The Z axis is provided along an upper-lower direction (height direction) of the towed vehicle 12. Hereinafter, unless otherwise specified, the front-rear direction, the width direction, and the upper-lower direction refer to the front-rear direction, the width direction, and the upper-lower direction of the towed vehicle 12.

Further, in this specification, an X direction, a Y direction, and a Z direction are defined. The X direction is a direction along the X axis, and includes a +X direction indicated by an arrow of the X axis and a −X direction in a direction opposite to the arrow of the X axis. The Y direction is a direction along the Y axis, and includes a +Y direction indicated by an arrow of the Y axis and a −Y direction in a direction opposite to the arrow of the Y axis. The Z direction is a direction along the Z axis, and includes a +Z direction indicated by an arrow of the Z axis and a −Z direction in a direction opposite to the arrow of the Z axis.

### Coupling Structure Between Towing Vehicle 10 and Towed Vehicle 12

A towing device 18 (hitch) used for towing the towed vehicle 12 protrudes from, for example, a lower portion of a central portion of a rear bumper 16 of the towing vehicle 10 in a vehicle width direction. The towing device 18 is fixed to, for example, a frame of the towing vehicle 10. The towing device 18 includes, as an example, a hitch ball 18a having a spherical tip end portion erected in a vertical direction (vehicle upper-lower direction), and the hitch ball 18a is covered with a coupler 20a provided at a tip end portion of a coupling member 20 in a front portion of the towed vehicle 12. As a result, the towing vehicle 10 and the towed vehicle 12 are coupled to each other, and the towed vehicle 12 can swing (pivot, rotate) in the vehicle width direction with respect to the towing vehicle 10. That is, the hitch ball 18a transmits front-rear and left-right movements to the towed vehicle 12 (the coupling member 20), and bears power of acceleration and deceleration. The coupling member 20 is included in the towed vehicle 12.

### Towed Vehicle Mark

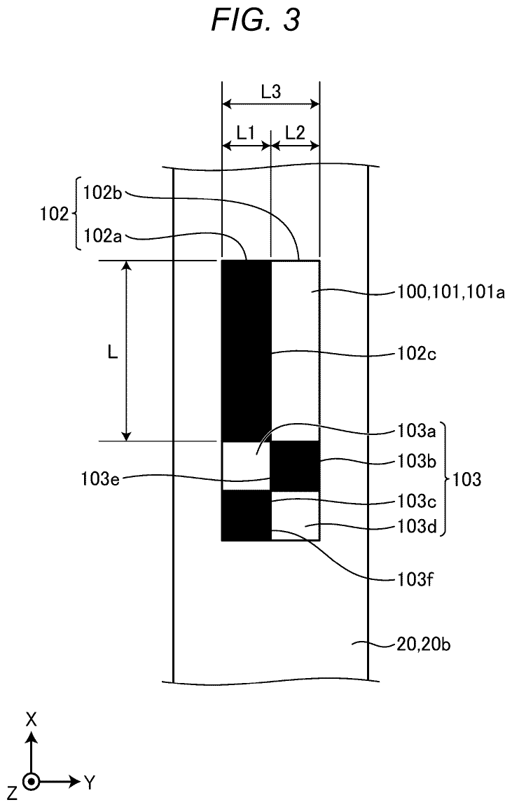

FIG. 3 is a plan view schematically illustrating an example of the coupling member 20 of the towed vehicle 12 provided with a towed vehicle mark 100 according to the embodiment. As illustrated in FIG. 3, the towed vehicle mark 100 (hereinafter, also referred to as the mark 100) is provided on an upper surface 20b of the coupling member 20 of the towed vehicle 12. The mark 100 is fixed to the upper surface 20b of the coupling member 20 by adhesion or the like. The mark 100 is provided on the coupling member 20 so as to be imaged by an imaging unit 24 in the towing vehicle 10. That is, the mark 100 is provided within an imaging range of the imaging unit 24 in the towing vehicle 10. The mark 100 is also referred to as a mark member.

The mark 100 includes a base material 101. The base material 101 is formed in a sheet shape (flat plate shape) and is fixed to the upper surface 20b of the coupling member 20. A mark main body 102 and a printed portion 103 are provided on an upper surface 101a of the base material 101.

The mark main body 102 includes a first region 102a and a second region 102b. Each of the first region 102a and the second region 102b has a rectangular shape in which the front-rear direction is set as a longitudinal direction and the left-right direction is set as a lateral direction. The first region 102a and the second region 102b are arranged adjacent to each other in the left-right direction. That is, the second region 102b is arranged adjacent to the first region 102a. The first region 102a and the second region 102b have different colors. As an example, the first region 102a is black, and the second region 102b is white. The colors of the first region 102a and the second region 102b are not limited to those described above.

A boundary line 102c between the first region 102a and the second region 102b is a straight line longer than a sum L3 of a width L1 of the first region 102a in an arrangement direction (left-right direction, Y direction) of the first region 102a and the second region 102b and a width L2 of the second region 102b in the arrangement direction. That is, the boundary line 102c is a straight line longer than a width (the sum L3) of the mark main body 102. Hereinafter, unless otherwise specified, the arrangement direction is the arrangement direction of the first region 102a and the second region 102b.

The printed portion 103 is provided adjacent to the mark main body 102. The printed portion 103 is located on a side in a direction intersecting the arrangement direction with respect to the mark main body 102, that is, with respect to the first region 102a and the second region 102b. As an example, the printed portion 103 is located on a front side (−X direction side) of the towed vehicle 12 in the front-rear direction (X direction) with respect to the first region 102a and the second region 102b. That is, the printed portion 103 is located on a side where the towing vehicle 10 is present with respect to the first region 102a and the second region 102b. The printed portion 103 is also referred to as a mark recognizer.

As an example, the printed portion 103 has a checkered pattern. Specifically, the printed portion 103 has four regions 103a to 103d. The regions 103a to 103d are squares. The region 103a is adjacent to the first region 102a on a front side of the first region 102a. The region 103a is white. The region 103b is adjacent to the second region 102b on a front side of the second region 102b. The region 103b is black. The region 103c is adjacent to the region 103a on a front side of the region 103a. The region 103c is black. The region 103d is adjacent to the region 103b on a front side of the region 103b. The region 103d is white.

A boundary line 103e between the region 103a and the region 103b and a boundary line 103f between the region 103c and the region 103d are aligned with the boundary line 102c between the first region 102a and the second region 102b. The boundary line 102c, the boundary line 103e, and the boundary line 103f form a straight line.

### Towing Vehicle 10

The imaging unit 24 is provided on a wall portion below a rear hatch 10a on the rear side of the towing vehicle 10. The imaging unit 24 is, for example, a digital camera including an imaging element such as a charge coupled device (CCD) or a CMOS image sensor (CIS). The imaging unit 24 can output video data (captured image data) at a predetermined frame rate. The imaging unit 24 has a wide-angle lens or a fisheye lens, and can have an imaging range of, for example, 140° to 220° in a horizontal direction. An optical axis of the imaging unit 24 is set obliquely downward. Therefore, the imaging unit 24 sequentially images a region (for example, a range indicated by two-dot chain lines, see FIG. 1) including a rear end portion of the towing vehicle 10, the coupling member 20, and at least a front end portion of the towed vehicle 12, and outputs the region as the captured image data. The captured image data captured by the imaging unit 24 can be used to recognize the towed vehicle 12 and detect a coupling state (for example, a bending angle, presence or absence of coupling) between the towing vehicle 10 and the towed vehicle 12. In this case, since the coupling state or the bending angle between the towing vehicle 10 and the towed vehicle 12 can be acquired based on the captured image data captured by the imaging unit 24, a system configuration can be simplified, and a load of calculation processing or image processing can be reduced. The towing vehicle 10 includes an imaging unit 24a that images a front region including a front bumper 16a of the towing vehicle 10 and that is located above the front bumper 16a of the towing vehicle 10. For example, when the towing vehicle 10 is in a state of being capable of travelling forward, an image indicating a situation in front of the towing vehicle 10 can be displayed on a display device 26. The towing vehicle 10 may include an imaging unit that images a side. Further, an imaging unit may be provided on a side or a rear of the towed vehicle 12. The calculation processing or the image processing may be performed based on captured image data obtained by a plurality of imaging units to generate an image having a wider viewing angle or generate a virtual overhead image (planar image) of the towing vehicle 10 when viewed from above.

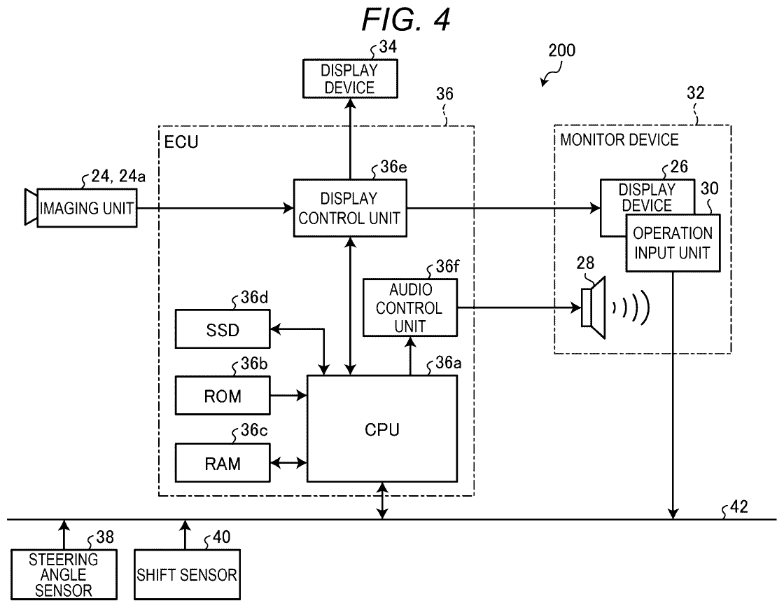

FIG. 4 is a block diagram illustrating a configuration of a periphery monitoring system including an ECU 36 as a mark detection device according to the embodiment. As illustrated in FIG. 4, the display device 26, an audio output device 28, and the like are provided in a vehicle cabin of the towing vehicle 10. The display device 26 is, for example, a liquid crystal display (LCD) or an organic electroluminescent display (OELD). The audio output device 28 is, as an example, a speaker. In the present embodiment, as an example, the display device 26 is covered with a transparent operation input unit 30 (for example, a touch panel). A driver (a user) can visually recognize a video (an image) displayed on a screen of the display device 26 via the operation input unit 30. The driver can perform an operation input (instruction input) by touching, pressing, or moving the operation input unit 30 with a finger or the like at a position corresponding to the video (image) displayed on the screen of the display device 26. In the present embodiment, as an example, the display device 26, the audio output device 28, the operation input unit 30, and the like are provided in a monitor device 32 located at a central portion of a dashboard in the vehicle width direction (left-right direction). The monitor device 32 can include an operation input unit (not illustrated) such as a switch, a dial, a joystick, and a push button. An audio output device (not illustrated) can be provided at another position in the vehicle cabin different from that of the monitor device 32, and audio can be output from the audio output device 28 of the monitor device 32 and another audio output device.

A display device 34 different from the display device 26 may be provided in the vehicle cabin of the towing vehicle 10. The display device 34 may be provided, for example, on an instrument panel portion of the dashboard. A size of a screen of the display device 34 can be smaller than a size of the screen of the display device 26. The display device 34 can simply display a trailer icon, a mark, or a message that indicates the towed vehicle 12 and that is displayed when the towed vehicle 12 coupled to the towing vehicle 10 has been recognized. An amount of information displayed on the display device 34 may be smaller than an amount of information displayed on the display device 26. The display device 34 is, for example, an LCD or an OELD. The display device 34 may be implemented by an LED or the like.

In a periphery monitoring system 200, in addition to the electronic control unit (ECU) 36 and the monitor device 32, a steering angle sensor 38, a shift sensor 40, and the like are electrically connected via an in-vehicle network 42 as a telecommunication line. The in-vehicle network 42 is implemented as, for example, a controller area network (CAN). The ECU 36 can receive detection results of the steering angle sensor 38, the shift sensor 40, and the like, operation signals of the operation input unit 30, and the like via the in-vehicle network 42, and reflect the detection results, the operation signals, and the like in control. The ECU 36 is an example of the mark detection device.

The ECU 36 includes, for example, a central processing unit (CPU) 36a, a read only memory (ROM) 36b, a random access memory (RAM) 36c, a solid state drive (SSD, flash memory) 36d, a display control unit 36e, and an audio control unit 36f. The CPU 36a can execute various calculation processing and control such as various image processing (straight line detection processing and bending angle detection processing) on the captured image data captured by the imaging unit 24, image processing related to images displayed on the display devices 26 and 34, recognition (detection) processing of the towed vehicle 12 coupled to the towing vehicle 10, and display processing based on detection results thereof.

The CPU 36a can read a program installed and stored in a non-volatile storage device such as the ROM 36b and execute the calculation processing according to the program. The RAM 36c temporarily stores various types of data used in calculations executed by the CPU 36a. The display control unit 36e mainly executes synthesis or the like of image data displayed on the display devices 26 and 34 among the calculation processing executed by the ECU 36. The audio control unit 36f mainly executes processing of audio data output by the audio output device 28 among the calculation processing executed by the ECU 36. The SSD 36d is a rewritable non-volatile storage unit, and can store data even when the ECU 36 is powered off. The CPU 36a, the ROM 36b, the RAM 36c, and the like may be integrated into the same package. Instead of the CPU 36a, the ECU 36 may include another logic calculation processor such as a digital signal processor (DSP), or a logic circuit. A hard disk drive (HDD) may be provided instead of the SSD 36d, and the SSD 36d or the HDD may be provided separately from the ECU 36.

The steering angle sensor 38 is, for example, a sensor that detects a steering amount (a steering angle of the towing vehicle 10) of a steering unit such as a steering wheel of the towing vehicle 10. The steering angle sensor 38 includes, for example, a Hall element. The ECU 36 acquires the steering amount of the steering unit by the driver, a steering amount of each wheel 14 during automated steering, and the like from the steering angle sensor 38, and executes various types of control. The steering angle sensor 38 detects a rotation angle of a rotation portion included in the steering unit. The steering angle sensor 38 is an example of an angle sensor.

The shift sensor 40 is, for example, a sensor that detects a position of a movable portion of a gear shift operation unit such as a shift lever. The shift sensor 40 can detect positions of a lever, an arm, a button, and the like as the movable portion. The shift sensor 40 may include a displacement sensor or may be implemented as a switch.

Configurations, arrangements, electrical connection forms, and the like of the various sensors described above and the like are merely examples, and can be set (changed) in various manners.

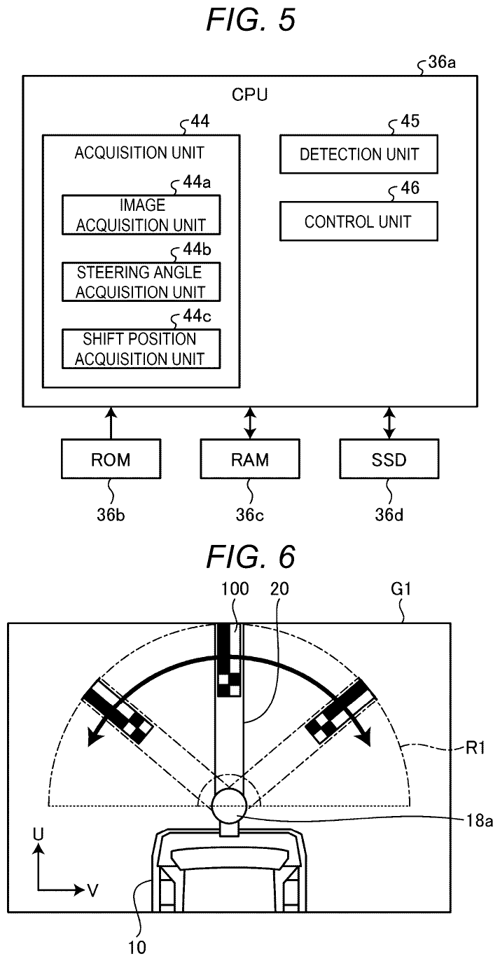

FIG. 5 is a block diagram illustrating a configuration of the CPU 36a included in the ECU 36. The CPU 36a includes various modules for implementing processing of detecting a straight line in the mark 100 in the captured image data, detecting the bending angle between the towing vehicle 10 and the towed vehicle 12, displaying an index based on the bending angle, and changing a display mode of the index. The various modules are implemented by the CPU 36a reading and executing the program installed and stored in the storage device such as the ROM 36b. For example, as illustrated in FIG. 5, the CPU 36a includes modules such as an acquisition unit 44, a detection unit 45, and a control unit 46. The acquisition unit 44 includes, for example, an image acquisition unit 44a, a steering angle acquisition unit 44b, and a shift position acquisition unit 44c.

The image acquisition unit 44a acquires a rear image (an image of a rear region) of the towing vehicle 10. The rear image is captured by the imaging unit 24 installed at a rear portion of the towing vehicle 10. That is, the image acquisition unit 44a (acquisition unit) acquires, from the imaging unit 24, the captured image data obtained by imaging the mark 100. The image acquisition unit 44a is an example of the acquisition unit.

The steering angle acquisition unit 44b acquires the steering angle of the towing vehicle 10 detected by the steering angle sensor 38. The shift position acquisition unit 44c acquires a shift position based on the position of the movable portion of the gear shift operation unit output by the shift sensor 40.

The detection unit 45 detects the mark 100 from captured image data G1, detects a straight line corresponding to the boundary line 102c from the detected mark 100, and detects the bending angle of the towed vehicle 12 with respect to the towing vehicle 10 based on the detected straight line. The bending angle is also referred to as a coupling angle.

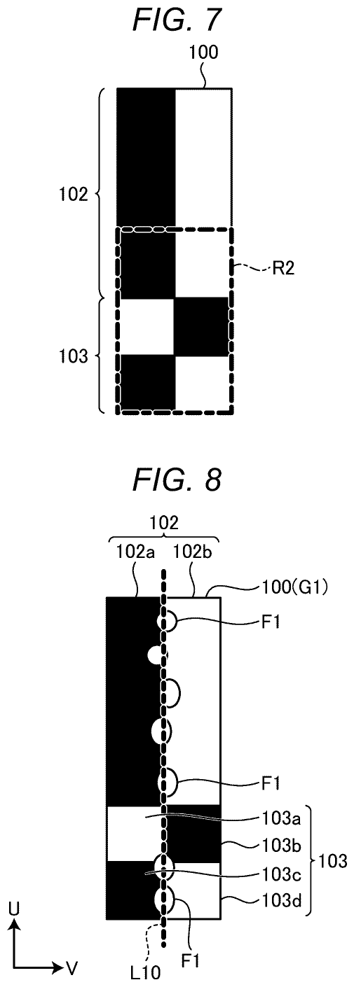

Detection processing of the straight line corresponding to the boundary line 102c from the mark 100 (straight line detection processing), which is executed by the detection unit 45, will be described with reference to FIGS. 6 to 8. FIG. 6 is a diagram illustrating an example of image processing and is a diagram illustrating processing of specifying a position of the mark 100 in the captured image data according to the embodiment. FIG. 7 is a diagram illustrating an example of image processing and is a diagram illustrating template matching processing according to the embodiment. FIG. 8 is a diagram illustrating an example of image processing and is a diagram illustrating straight line detection processing according to the embodiment.

As illustrated in FIG. 6, the detection unit 45 converts the captured image data G1 into an overhead image using a known method. Then, the detection unit 45 detects the position of the mark 100 by executing template matching on a predetermined range R1 in the captured image data G1 converted into the overhead image. The predetermined range R1 can be set in, for example, calibration processing (initial setting processing). The calibration processing is executed, for example, in a state where the mark 100 is fixed to the towed vehicle 12. In the calibration processing, the mark 100 is imaged by the imaging unit 24 when the towing vehicle 10 moves forward in a state where the towing vehicle 10 and the towed vehicle 12 are aligned in a row. Accordingly, the mark 100 in the captured image data G1 is detected, and a semicircular range obtained by moving the mark 100 around the hitch ball 18a in the captured image data G1 is set as the predetermined range R1. In the calibration processing, a correction value (offset amount) used for calculating the bending angle is calculated. In this manner, the detection unit 45 specifies (detects) a rough position of the mark 100 by template matching.

Template image data used for the template matching is a partial region R2 in the mark 100 as illustrated in FIG. 7. The partial region R2 includes, for example, the printed portion 103 and a part of the mark main body 102 (the first region 102a and the second region 102b). In this manner, since the template image data is the partial region R2 in the mark 100, a data processing amount of the template matching processing is likely to be reduced.

The detection unit 45 executes the straight line detection processing on the mark 100 in the detected captured image data G1, and detects the straight line corresponding to the boundary line 102c from the mark 100. Various methods can be used for the straight line detection processing. For example, the straight line detection processing may be executed using a random sample consensus (RANSAC) method.

As illustrated in FIG. 8, a plurality of edges F1 (feature points) are detected in the straight line detection processing. The plurality of edges F1 are, for example, portions that change from black to white in a + direction of a V axis in a UV coordinate system set in the captured image data G1. A straight line L10 is calculated based on the plurality of edges F1 using a known method. That is, the straight line L10 corresponds to the boundary line 102c. In the present embodiment, the straight line L10 corresponds to the boundary line 102c and the boundary line 103f. A U axis (vertical axis) in the UV coordinate system is along the front-rear direction of the towing vehicle 10, and the V axis (horizontal axis) in the UV coordinate system is along the left-right direction of the towing vehicle 10. In this manner, by detecting the straight line L10 based on the plurality of edges F1, accuracy of detecting the straight line L10 is improved as compared with, for example, a case where the straight line is detected based on one feature point.

The detection unit 45 calculates the bending angle between the towing vehicle 10 and the towed vehicle 12 using a known method based on the detected straight line L10. At this time, for example, the correction value calculated in the calibration processing is used.

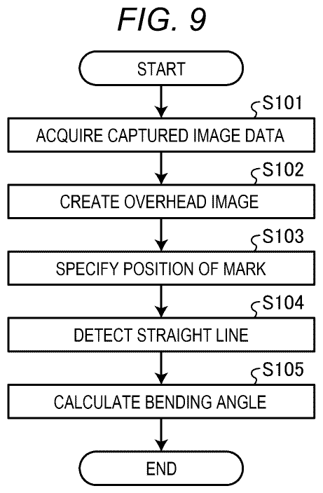

Next, an example of the straight line detection processing as processing executed by the CPU 36a will be described with reference to FIG. 9. FIG. 9 is a flowchart illustrating an example of the processing executed by the CPU 36a according to the embodiment.

First, the CPU 36a acquires captured image data from the imaging unit 24 (S101) and creates an overhead image (S102).

Next, the CPU 36a specifies (detects) a position of the mark 100 in the captured image data converted into the overhead image (S103), and detects the straight line L10 corresponding to the mark 100 (S104). Then, the CPU 36a specifies (detects) the position of the mark 100 in the captured image data converted into the overhead image based on the straight line L10 (S103), and calculates the bending angle between the towing vehicle 10 and the towed vehicle 12 (S105).

### Overview

As described above, the mark 100 (towed vehicle mark) according to the present embodiment is to be provided on the towed vehicle 12 that is couplable to the towing vehicle 10 so as to be imaged by the imaging unit 24 in the towing vehicle 10. The mark 100 includes the first region 102a and the second region 102b. The second region 102b is arranged adjacent to the first region 102a and has a color different from a color of the first region 102a. The boundary line 102c between the first region 102a and the second region 102b is a straight line longer than the sum L3 of the width L1 of the first region 102a in the arrangement direction (Y direction) of the first region 102a and the second region 102b and the width L2 of the second region 102b in the arrangement direction.

According to this configuration, since the boundary line 102c between the first region 102a and the second region 102b is a straight line longer than the sum L3 of the width L1 of the first region 102a in the arrangement direction of the first region 102a and the second region 102b and the width L2 of the second region 102b in the arrangement direction, it is possible to improve the accuracy of detecting the boundary line 102c, that is, detecting the straight line L10 from the mark 100 by the ECU 36. Therefore, according to the above configuration, the accuracy of detecting the bending angle of the towed vehicle 12 can be improved.

In addition, the mark 100 includes the printed portion 103 on a side in a direction intersecting the arrangement direction with respect to the first region 102a and the second region 102b.

According to this configuration, since the position of the mark 100 in the captured image data G1 can be specified using a part of the mark 100 including the printed portion 103, the processing amount of the straight line detection processing executed by the ECU 36 is likely to be reduced.

The printed portion 103 is located on a side where the towing vehicle 10 is present with respect to the first region 102a and the second region 102b.

According to this configuration, since a resolution of the printed portion 103 in the captured image data G1 obtained by imaging by the imaging unit 24 is likely to be increased as compared with a case where the printed portion 103 is located on a side where the towing vehicle 10 is not present with respect to the first region 102a and the second region 102b, it is easy to detect the printed portion 103 by the ECU 36.

The ECU 36 (mark detection device) according to the present embodiment includes the image acquisition unit 44a (acquisition unit) and the detection unit 45. The image acquisition unit 44a (acquisition unit) acquires, from the imaging unit 24, the captured image data G1 obtained by imaging the mark 100. The detection unit 45 detects the mark 100 from the captured image data G1, and detects the straight line L10 corresponding to the boundary line 102c from the detected mark 100.

According to this configuration, since the boundary line 102c between the first region 102a and the second region 102b is a straight line longer than the sum L3 of the width L1 of the first region 102a in the arrangement direction of the first region 102a and the second region 102b and the width L2 of the second region 102b in the arrangement direction, it is possible to improve the accuracy of detecting the boundary line 102c, that is, detecting the straight line L10 from the mark 100 by the ECU 36.

A periphery monitoring program executed by the CPU 36a according to the present embodiment may be provided by being recorded in a computer-readable recording medium such as a CD-ROM, a flexible disk (FD), a CD-R, or a digital versatile disk (DVD) in an installable or executable file format.

Further, the periphery monitoring program may be stored on a computer connected to a network such as the Internet and provided by being downloaded via the network. The periphery monitoring program executed in the present embodiment may be provided or distributed via the network such as the Internet.

In the above embodiment, an example in which the printed portion 103 has a checkered pattern has been described, but this disclosure is not limited thereto. For example, the printed portion 103 may be a circle, a polygon, an emblem of a company or a product, or the like.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A towed vehicle mark to be provided on a towed vehicle that is couplable to a towing vehicle so as to be imaged by an imaging unit in the towing vehicle, the towed vehicle mark comprising:
a first region; and
a second region arranged adjacent to the first region and having a color different from a color of the first region, wherein
a boundary line between the first region and the second region is a straight line longer than a sum of a width of the first region in an arrangement direction of the first region and the second region and a width of the second region in the arrangement direction.

2. The towed vehicle mark according to claim 1, further comprising:
a printed portion on a side in a direction intersecting the arrangement direction with respect to the first region and the second region.

3. The towed vehicle mark according to claim 2, wherein
the printed portion is located on a side where the towing vehicle is present with respect to the first region and the second region.

4. A mark detection device comprising:
an acquisition unit configured to acquire captured image data obtained by imaging the towed vehicle mark according to claim 1 from the imaging unit; and
a detection unit configured to detect the towed vehicle mark from the captured image data and detect a straight line corresponding to the boundary line from the detected towed vehicle mark.

5. A mark detection device comprising:
an acquisition unit configured to acquire captured image data obtained by imaging the towed vehicle mark according to claim 2 from the imaging unit; and
a detection unit configured to detect the towed vehicle mark from the captured image data and detect a straight line corresponding to the boundary line from the detected towed vehicle mark.

6. A mark detection device comprising:
an acquisition unit configured to acquire captured image data obtained by imaging the towed vehicle mark according to claim 3 from the imaging unit; and
a detection unit configured to detect the towed vehicle mark from the captured image data and detect a straight line corresponding to the boundary line from the detected towed vehicle mark.
